(19) United States
(12) Patent Application Publication
(10) Pub. No.: US 2007/0198529 A1
(43) Pub. Date: Aug. 23, 2007

(54) Management computer and communication system

(76) Inventor: Yukio Ogawa, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/367,598

(22) Filed: Mar. 6, 2006

(30) Foreign Application Priority Data
Feb. 14, 2006 (JP) 2006-036198

(51) Int. Cl. G06F 17/30

(52) U.S. Cl. 707/10

(57) ABSTRACT

Provided is a technique capable of calculating a processing time of a server apparatus. A management computer connected to a server apparatus which is connected to a terminal computer through a network, includes a processor; a memory; and an interface. The processor acquires packets outputted from the server apparatus and packets inputted to the server apparatus, estimates a time at which the server apparatus starts to process the input packets, estimates a time at which the server apparatus completes the response to the input packets on the basis of a time change in the number of acquired output packets, and calculates the packet processing time of the server apparatus by subtracting the estimated processing start time from the estimated response completion time.

### CLAIM OF PRIORITY

The present application claims priority from Japanese patent application P2006-36198 filed on Feb. 14, 2006, the content of which is hereby incorporated by reference into this application.

### BACKGROUND

The present invention relates to a management computer connected to a server apparatus, and more particularly, to a technique for managing communications between a server apparatus and a terminal computer.

In a communication system having a server apparatus, a terminal computer connected to the server apparatus through a network, there has been a problem in that an administrator cannot identify a cause of a processing delay in a case where the processing is delayed. For example, the administrator cannot determine whether the processing delay is caused by a processing time duration of the server apparatus or a network communication time duration between the terminal computer and the server apparatus.

As a technique for solving the problem, a network delay determining apparatus is disclosed in JP 8-9035 A. The network delay determining apparatus obtains a difference between a traffic load attributable to an input message and a traffic load attributable to an output message to thereby calculate a total value of the network communication time duration and the processing time duration of the server apparatus.

As another technique for solving the above problem, an adaptive quality control apparatus is disclosed in JP 2003-258881 A. The adaptive quality control apparatus calculates a response time duration of a traffic flow on the basis of a response time of an SYN packet and a response time of an ACK packet with respect to an SYN-ACK packet.

### SUMMARY

The conventional network delay determining apparatus uses a correspondence of the number of input messages to the number of output messages. Accordingly, in a case where the number of output messages is far larger than the number of input messages, the conventional network delay determining apparatus cannot calculate the processing time duration of the server apparatus.

Also, the conventional adaptive quality control apparatus must identify the SYN packet and the ACK packet with respect to the SYN-ACK packet. Accordingly, the conventional adaptive quality control apparatus must analyze a communication protocol. Accordingly, in a case where a format of the communication protocol is unknown, the conventional adaptive quality control apparatus cannot calculate the response time duration of the traffic flow. The case in which the format of the communication protocol is unknown is directed to, for example, a case in which a communication between the server apparatus and the terminal computer is encoded.

The present invention has been made in view of the above circumstances, and therefore has an object to provide a communication system in which a processing time duration of the server apparatus is calculated.

According to a representative embodiment of this invention, there is provided a management computer connected to a server apparatus which is connected to a terminal computer through a network, the management computer being characterized by including: a processor; a memory; and an interface, and characterized in that the processor acquires packets outputted from the server apparatus and packets inputted to the server apparatus, estimates a time at which the server apparatus starts to process the input packets, estimates a time at which the server apparatus completes the response to the input packets based on a time change in a number of acquired output packets, and calculates the packet processing time duration of the server apparatus by subtracting the estimated processing start time from the estimated response completion time.

According to this invention, the processing time duration of the server apparatus can be calculated.

### BRIEF DESCRIPTION OF THE DRAWINGS

The present invention can be appreciated by the description which follows in conjunction with the following figures, wherein:

FIG. 1 is a block diagram showing a structure of a communication system;

FIG. 2 is a block diagram showing a structure of a management computer;

FIG. 3 is an explanatory diagram showing a response time duration, a network communication time duration, and a processing time duration;

FIG. 4 is an explanatory diagram showing a response time duration, a network communication time duration, and a processing time duration;

FIG. 5 is a flowchart showing the processing of the management computer;

FIG. 6 is an explanatory diagram showing a process of calculating a processing time duration of the server apparatus which is conducted by the management computer;

FIG. 7 is an explanatory diagram showing a specifying process of the type of an application program which is conducted by the management computer;

FIG. 8 is an explanatory diagram showing a display screen related to an analysis result of packet information;

FIG. 9 is an explanatory diagram showing a display screen related to an analysis result of packet information;

FIG. 10 is an explanatory diagram showing a display screen related to an analysis result of packet information; and

FIG. 11 is an explanatory diagram showing a threshold value related to a response time duration of the server apparatus.

### DETAILED DESCRIPTION OF THE PREFERRED EMBODIMENTS

Hereinafter, an embodiment of this invention will be described with reference to the drawings.

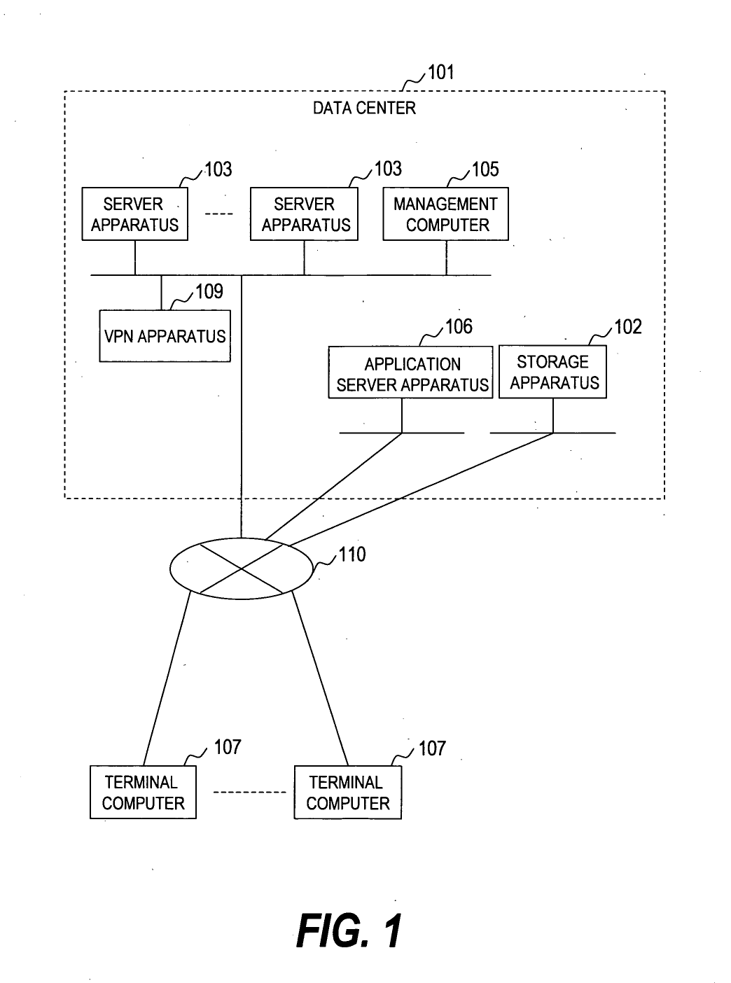

FIG. 1 is a block diagram showing a structure of a communication system.

The communication system includes a data center 101, a network 110, and a plurality of terminal computers 107.

Each of the terminal computers 107 is operated by a user. Also, the terminal computer 107 includes a CPU, a memory, and an interface.

The data center 101 includes a plurality of server apparatuses 103, a storage apparatus 102, a management computer 105, an application server apparatus 106, and a VPN (virtual private network) apparatus 109.

The server apparatus 103, the management computer 105, and the VPN apparatus 109 are connected to one local area network (LAN). Also, the application server apparatus 106 and the storage apparatus 102 may be connected to the LAN. The LAN is constituted of a hub or a switch.

Although two server apparatuses 103 are shown in FIG. 1, the number of server apparatuses 103 may not be limited. Also, the server apparatus 103 is connected to the terminal computer 107 through the network 110. For example, the server apparatus 103 and the terminal computer 107 communicate with each other through a communication protocol such as TCP (transmission control protocol).

One server apparatus 103 may be connected to one terminal computer 107, or may be connected to a plurality of terminal computers 107. The network 110 may be structured by the Internet or an intranet.

The server apparatus 103 includes a CPU, a memory, and an interface. Also, the server apparatus 103 may include a storage device, a display device, and an input device, or may not include those devices. Also, each of the server apparatuses 103 may be structured by a computer base having a CPU, a memory, and an interface included in one casing.

In this embodiment, each of the server apparatuses 103 includes a terminal server function. For that reason, the server apparatus 103 executes an application program required by the terminal computer 107.

More specifically, the terminal computer 107 transmits information that has been inputted through a keyboard or a mouse to the server apparatus 103 by means of a dedicated communication protocol. Then, the server apparatus 103 processes the received input information by the application program to produce screen information and transmits the produced screen information to the terminal computer 107. The terminal computer 107 displays the received screen information.

The server apparatus 103 may include another function such as a web server apparatus function without including a terminal server function.

In a case where the network 110 is the Internet, a VPN apparatus 109 is included in the data center 101. The VPN apparatus 109 produces virtual tunnels connected to the respective terminal computers 107. Then, the VPN apparatus 109 transmits and receives data to and from the terminal computers 107 through the virtual tunnels. The virtual tunnels are safe communication paths that are encrypted. Also, a protocol such as IPsec (IP security protocol) is used for encryption.

Now, a description will be given of a communication of the terminal computer 107 with the server apparatus 103 in a case where the VPN apparatus 109 is equipped within the data center 101.

First, the terminal computer 107 encrypts a packet. Then, the terminal computer 107 transmit the encrypted packet to the VPN apparatus 109. The VPN apparatus 109 decrypts the received encrypted packet. Then, the VPN apparatus 109 transfers the decrypted packet to the server apparatus 103.

The application server apparatus 106 is structured by a computer having a CPU, a memory, and an interface. Also, the application server apparatus 106 provides the server apparatus 103 with a function required for execution of an application to the server apparatus 103. The functions necessary for the application include a web server function, a mail server function, or a filer server function. The server apparatus 103 and the application server apparatus 106 are connected to each other through the network 110. The server apparatus 103 and the application server apparatus 106 may be connected to each other by a LAN.

The terminal computer 107 uses the application server apparatus 106 through the server apparatus 103. More specifically, the terminal computer 107 accesses an application program installed in the server apparatus 103 through a terminal server function installed in the server apparatus 103. Then, the application program installed in the server apparatus 103 accesses the application server apparatus 106 to acquire the information. Then, the application program installed in the server apparatus 103 transfers the acquired information to the terminal computer 107 through the terminal server function installed in the server apparatus 103.

The storage apparatus 102 provides the server apparatus 103 with a storage area. For example, the storage apparatus 102 includes a physical disk for storing information therein and a disk controller for controlling the physical disk.

The storage apparatus 102 and the server apparatus 103 are connected to each other through the network 110. For example, the storage apparatus 102 and the server apparatus 103 communicate with each other by using a communication protocol such as iSCSI. The storage apparatus 102 and the server apparatus 103 may be connected to each other by a LAN.

The terminal computer 107 uses the storage apparatus 102 through the server apparatus 103. More specifically, the terminal computer 107 accesses the application program installed in the server apparatus 103 through the terminal server function installed in the server apparatus 103. Then, the application program installed in the server apparatus 103 acquires the information from the storage apparatus 102 and transfers the acquired information to the terminal computer 107 through the terminal server function.

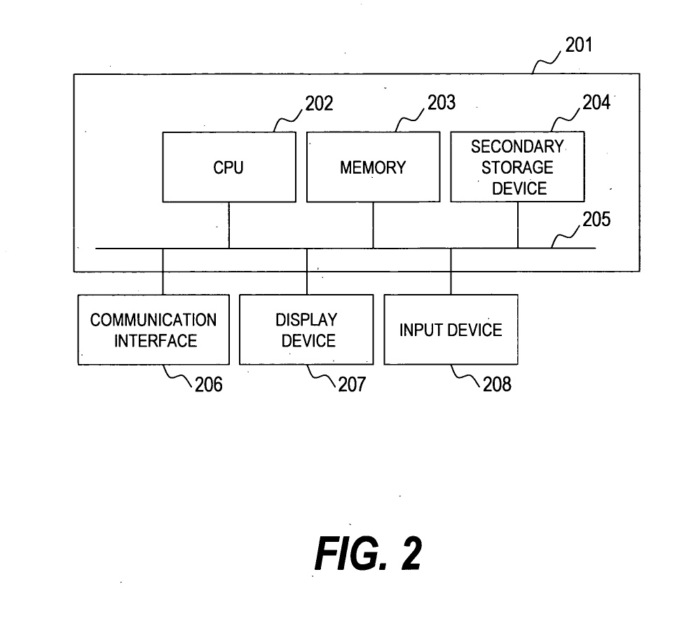

The management computer 105 monitors the communication of the server apparatus 103 to thereby identify a cause of the processing delay of the communication system. The management computer 105 will be described in more detail with reference to FIG. 2.

For example, a user of the terminal computer 107 feels a processing delay. In this case, the management computer 105 calculates: a processing time duration of the server apparatus 103; a network communication time duration of the terminal computer 107 and the server apparatus 103; a response time duration of the application server apparatus 106; a network communication time duration of the server apparatus 103 and the application server apparatus 106; a response time duration of the storage apparatus 102; and a network communication time duration of the server apparatus 103 and the storage apparatus 102. The management computer 105 determines whether or not the calculated processing time duration, response time durations, network communication time durations are abnormal values to thereby specify the cause of the processing delay of the communication system.

FIG. 2 is a block diagram showing a structure of the management computer 105.

The management computer 105 has a structure identical with that of a normal computer. More specifically, the management computer 105 includes a CPU 202, a memory 203, a secondary storage device 204, an internal signal line 205, a communication interface 206, a display device 207, and an input device 208. The CPU 202, the memory 203, the storage device 204, and the internal signal line 205 are disposed within a casing 201.

The CPU 202 executes a program stored in the memory 203 to thereby execute various processings. The memory 203 stores therein a program to be executed by the CPU 202 and information to be required by the CPU 202.

The secondary storage device 204 is formed of, for example, a hard disk. The secondary storage device 204 stores various information therein. The internal signal line 205 is formed of, for example, a bus. The internal signal line 205 connects the CPU 202, the memory 203, the secondary storage device 204, the communication interface 206, the display device 207, and the input device 208 to one another.

The communication interface 206 is connected to the server apparatus 103 through a LAN. The display device 207 displays various information. The input device 208 is formed of, for example, a keyboard or a mouse.

Then, a description will be given of the response time duration, the network communication time duration, and the processing time duration.

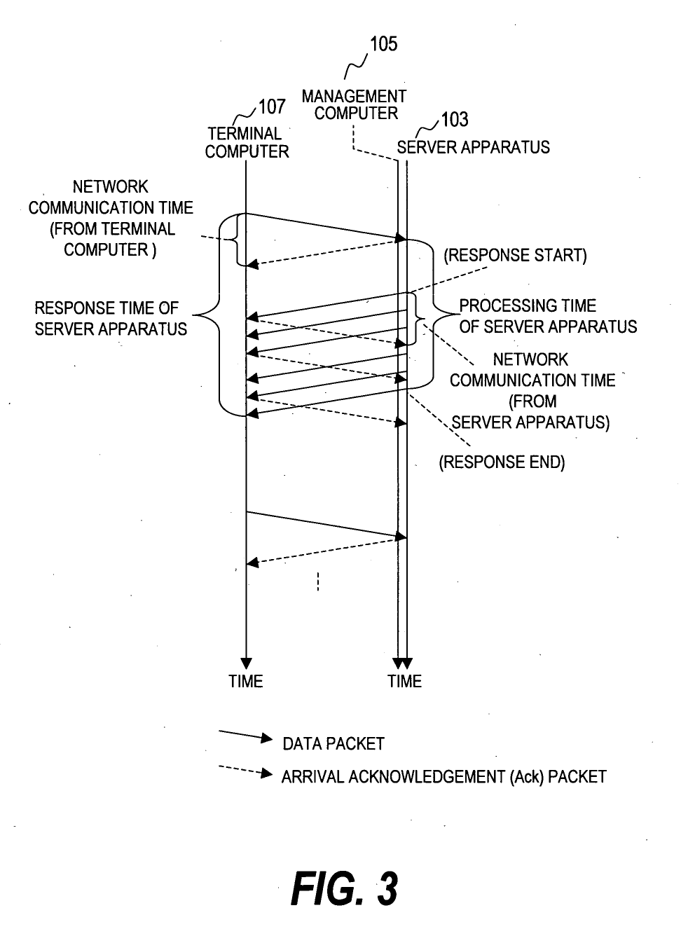

FIG. 3 is an explanatory diagram showing the response time duration, the network communication time duration, and the processing time duration.

In this embodiment, a description will be given of the processing time duration of the server apparatus 103, the response time duration of the server apparatus 103, and the network communication time duration of the terminal computer 107 and the server apparatus 103. The network communication time duration of the terminal computer 107 and the server apparatus 103 is any one of the network communication time duration from the terminal computer 107, and the network communication time duration from the server apparatus 103.

First, the terminal computer 107 transmits data packet to the server apparatus 103. The server apparatus 103 transmits an arrival acknowledgement (ACK) packet to the terminal computer 107 upon reception of the data packet. Then, the terminal computer 107 receives the ACK packet from the server apparatus 103.

On the other hand, the server apparatus 103 conducts processing for the received data packet. Then, the server apparatus 103 transmits the data packet including a response to the received data packet to the terminal computer 107. Alternatively, the server apparatus 103 may divide the response to the received data packets into a plurality of pieces to transmit a plurality of data packets including the response.

In this case, a time at which a first data packet including the response is transmitted is a response start time. Also, a time at which a final data packet including the response is transmitted is a response end time.

Then, the terminal computer 107 receives the data packet including the response from the server apparatus 103. The terminal computer 107 transmits the ACK packet to the server apparatus 103 upon reception of the data packet including the response. Then, the server apparatus 103 receives the ACK packet from the terminal computer 107.

In this example, a network communication time duration. from the terminal computer 107 corresponds to an amount of time between when the terminal computer 107 transmits the data packet and when the terminal computer 107 receives the ACK packet with respect to the data packet.

Also, a network communication time duration from the server apparatus 103 corresponds to an amount of time between when the server apparatus 103 transmits the data packet and when the server apparatus 103 receives the ACK packet with respect to the data packet.

Also, the processing time duration of the server apparatus 103 corresponds to an amount of time between when the server apparatus 103 receives the data packet and when the server apparatus 103 transmits the final data packet including the response with response to the data packet.

Also, the response time duration of the server apparatus 103 corresponds to an amount of time between when the terminal computer 107 transmits the data packet and when the terminal computer 107 receives the final data packet including the response with respect to the data packet.

The management computer 105 acquires the packets in the vicinity of the server apparatus 103. For that reason, the management computer 105 is capable of calculating the network communication time duration from the server apparatus 103 and the processing time duration of the server apparatus 103. However, the management computer 105 is not capable of calculating the network communication time duration from the terminal computer 107 and the response time duration of the server apparatus 103.

Under the above circumstances, the management computer 105 estimates the network communication time duration from the terminal computer 107 on the basis of the network communication time duration from the server apparatus 103. For example, the management computer 105 estimates that the network communication time duration from the server apparatus 103 and the network communication time duration from the terminal computer 107 are identical with each other.

Also, the management computer 105 adds the estimated network communication time duration from the terminal computer 107 to the calculated processing time duration of the server apparatus 103, to thereby calculate the response time duration of the server apparatus 103.

That is, the management computer 105 acquires the packets in the vicinity of the server apparatus 103, thereby making. it possible to calculate the response time duration of the server apparatus 103. For that reason, the management computer 105 is capable of determining whether or not the user of the terminal computer 107 feels the processing delay. For example, the management computer 105 compares the response time duration of the server apparatus 103 with a threshold value related to the, response time duration of the server apparatus 103, to thereby determine whether or not the user of the terminal computer 107 feels the processing delay.

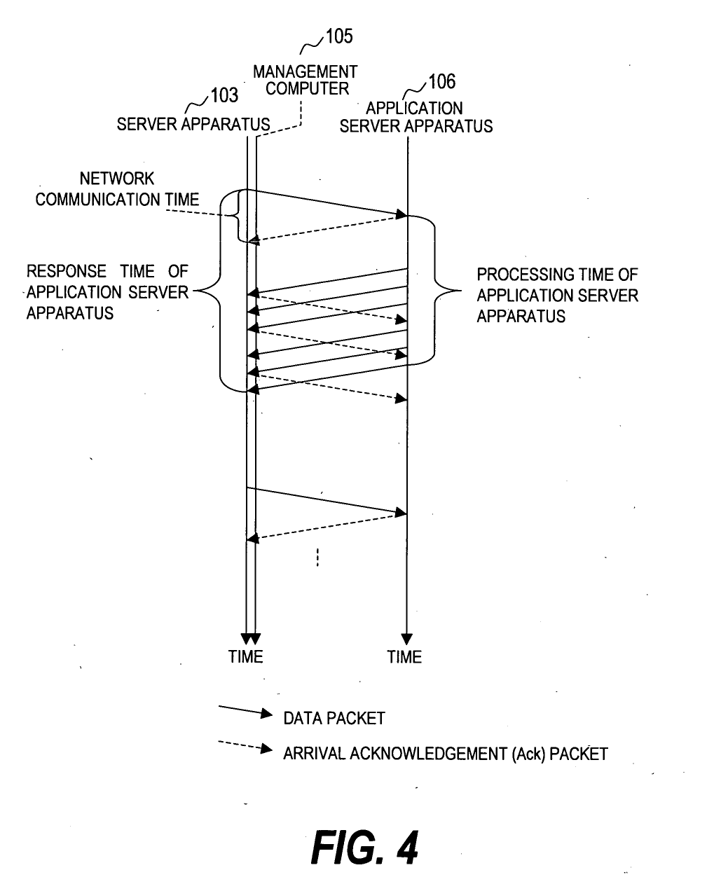

FIG. 4 is an explanatory diagram showing the response time duration, the network communication time duration, and the processing time duration.

In this embodiment, a description will be given of the processing time duration of the application server apparatus 106, the response time duration of the application server apparatus 106, and the network communication time duration of the server apparatus 103 and the application server apparatus 106.

First, the server apparatus 103 transmits a data packet to the application server apparatus 106. The application server apparatus 106 transmits an arrival acknowledgement (ACK) packet to the server apparatus 103 upon reception of the data packet. Then, the server apparatus 103 receives the ACK packet from the application server apparatus 106.

On the other hand, the application server apparatus 106 conducts processing for the received data packet. Then, the application server apparatus 106 transmits the data packet including a response to the received data packet to the server apparatus 103. Alternatively, the application server apparatus 106 may divide the response to the received data packet into a plurality of pieces to transmit a plurality of data packets including the response.

Then, the server apparatus 103 receives the data packet including the response from the application server apparatus 106. The server apparatus 103 transmits the ACK packet to the application server apparatus 106 upon reception of the data packet including the response. Then, the application server apparatus 106 receives the ACK packet from the server apparatus 103.

In this example, a network communication time duration of the server apparatus 103 and the application server apparatus 106 corresponds to an amount of time between when the server apparatus 103 transmits the data packets and when, the application server apparatus 106 receives the ACK packet with respect to the data packet.

Also, the processing time duration of the application server apparatus 106 corresponds to an amount of time between when the application server apparatus 106 receives the data packet and when the application server apparatus 106 transmits the final data packet including the response with response to the data packet.

Also, the response time duration of the application server apparatus 106 corresponds to an amount of time between when the server apparatus 103 transmits the data packet and when the server apparatus 103 receives the final data packet including the response with respect to the data packet.

The management computer 105 acquires a data packet in the vicinity of the server apparatus 103. For that reason, the management computer 105 is capable of calculating the response time duration of the application server apparatus 106, and the network communication time duration of the server apparatus 103 and the application server apparatus 106 through the protocol analysis.

Then, the management computer 105 subtracts the calculated network communication time duration of the server apparatus 103 and the application server apparatus 106 from the calculated response time duration of the application server apparatus 106, to thereby calculate the processing time duration of the application server apparatus 106.

Subsequently, a description will be given of the processing time duration of the storage apparatus 102, the response time duration of the storage apparatus 102, and the network communication time duration of the server apparatus 103 and the storage apparatus 102.

First, the server apparatus 103 transmits data packets to the storage apparatus 102. The storage apparatus 102 transmits arrival acknowledgement (ACK) packet to the server apparatus 103 upon reception of the data packet. Then, the server apparatus 103 receives the ACK packet from the storage apparatus 102.

On the other hand, the storage apparatus 102 conducts processing for the received data packet. Then, the storage apparatus 102 transmits the data packet including a response to the received data packet to the server apparatus 103. Alternatively, the storage apparatus 102 may divide the response to the received data packet into a plurality of pieces to transmit a plurality of data packets including the response.

Then, the server apparatus 103 receives the data packet including the response from the storage apparatus 102. The server apparatus 103 transmits the ACK packet to the storage apparatus 102 upon reception of the data packet including the response. Then, the storage apparatus 102 receives the ACK packet from the server apparatus 103.

In this example, a network communication time duration of the server apparatus 103 and storage apparatus 102 corresponds to an amount of time between when the server apparatus 103 transmits the data packet and when the server apparatus 103 receives the ACK packet with respect to the data packet.

Also, the processing time duration of the storage apparatus 102 corresponds to an amount of time between when the storage apparatus 102 receives the data packet and when the storage apparatus 102 transmits the final data packet including the response with response to the data packet.

Also, the response time duration of the storage apparatus 102 corresponds to an amount of time between when the server apparatus 103 transmits the data packet and when the server apparatus 103 receives the final data packet including the response with respect to the data packet.

The management computer 105 acquires the packets in the vicinity of the server apparatus 103. For that reason, the management computer 105 is capable of calculating the response time duration of the storage apparatus 102 and the network communication time duration of the server apparatus 103 and the storage apparatus 102 through the protocol analysis.

Then, the management computer 105 subtracts the calculated network communication time duration of the server apparatus 103 and the storage apparatus 102 from the calculated response time duration of the storage apparatus 102, to thereby calculate the processing time duration of the storage apparatus 102.

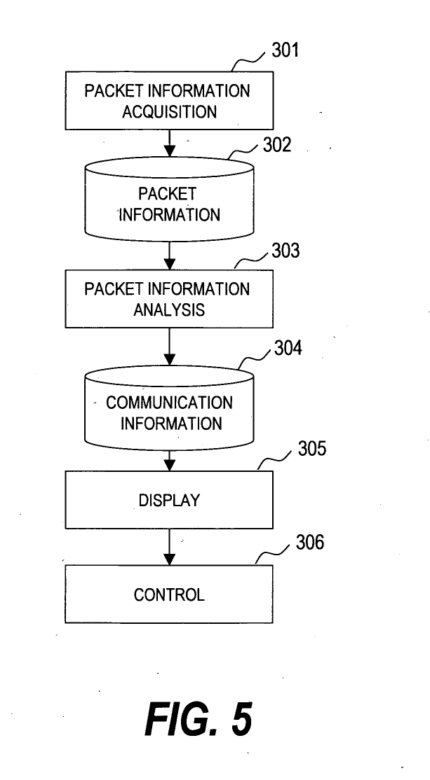

FIG. 5 is a flowchart showing the processing of the management computer 105.

This processing is conducted when the user of the terminal computer 107 feel the processing delay.

First, the management computer 105 acquires all of the packets that are inputted to the server apparatus 103 and the packets that are outputted from the server apparatus 103 (301).

In this example, the acquisition of the packets will be described. A switch, a hub, or the like which constitutes the LAN mirrors a port that is connected with the server apparatus 103 to a port that is connected with the management computer 105. With the above structure, the management computer 105 is capable of acquiring the packets that are inputted to the server apparatus 103 and the packets that are outputted from the server apparatus 103.

The management computer 105 may acquire only a specific packet without acquiring all of the packets. More specifically, the management computer 105 filters the packets on the basis of the IP address of the server apparatus 103, the type of protocol, or TCP port number, and then acquires the packets. As a result, the management computer 105 is capable of reducing the amount of acquired packets.

Subsequently, the management computer 105 analyzes the acquired packets. Then, the management computer 105 stores the analysis result in a database as packet information (302). The packet information includes protocol header information included in the packet.

Then, the management computer 105 analyzes the packet information that is stored in the database (303). More specifically, the management computer 105 calculates at least one of the processing time duration of the server apparatus 103, the network communication time duration from the server apparatus 103, the response time duration of the application server apparatus 106, the network communication time duration of the server apparatus 103 and the application server apparatus 106, the response time duration of the storage apparatus 102, and the network communication time duration of the server apparatus 103 and the storage apparatus 102 on the basis of the packet information that is stored in the database.

First, a description will be given of the calculation of the network communication time duration from the server apparatus 103.

The management computer 105 acquires the packets that are transmitted from the terminal computer 107 to the server apparatus 103 and the packets that are transmitted from the server apparatus 103 to the terminal computer 107 between the VPN apparatus 109 and the server apparatus 103. The packets are not encrypted between the VPN apparatus 109 and the server apparatus 103.

Under the circumstances, the management computer 105 analyzes the communication protocol of the acquired packets to calculate the network communication time duration from the server apparatus 103.

More specifically, the management computer 105 calculates a difference between a time at which the data packets that are transmitted from the server apparatus 103 to the terminal computer 107 are acquired and a time at which the ACK packets with respect to the data packets are acquired, to thereby calculate the network communication time duration from the server apparatus 103.

The management computer 105 acquires the data packets in the vicinity of the server apparatus 103. For that reason, the management computer 105 deals with the time at which the data packets that are transmitted from the server apparatus 103 to the terminal computer 107 are acquired as a time at which the server apparatus 103 transmits the data packet. Also, the management computer 105 deals with the time at which the ACK packet is acquired as the time at which the server apparatus 103 receives the ACK packet.

Subsequently, a description will be given of the calculation of the processing time duration of the server apparatus 103. In this embodiment, the terminal computer 107 accesses the terminal server function provided in the server apparatus 103. For that reason, the data for using the terminal server function is encrypted and stored in the data area of the packets.

Under the circumstances, the management computer 105 is incapable of identifying the start time and the end time of the processing of the server apparatus 103 based on the acquired data packets. In other words, the management computer 105 is incapable of calculating the processing time duration of the server apparatus 103 by analyzing the communication protocol of the packets.

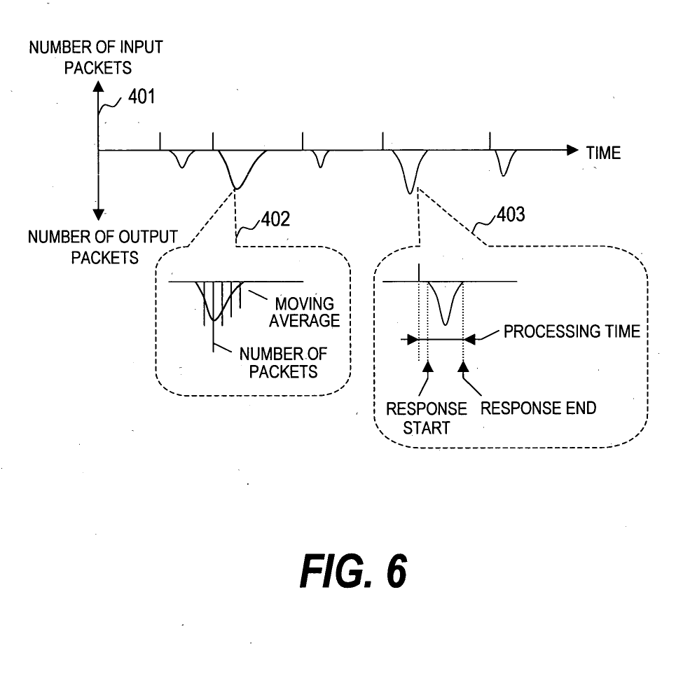

For that reason, the management computer 105 calculates the processing time duration of the server apparatus 103 with reference to a time change in the number of packets which are outputted from the server apparatus 103 to the terminal computer 107. The calculation of the processing time duration of the server apparatus 103 by the management computer 105 will be described in more detail with reference to FIG. 6.

Subsequently, a description will be given of the calculation of the network communication time duration of the server apparatus 103 and the application server apparatus 106.

The management computer 105 calculates the communication protocol of the acquired packets, to thereby calculate the network communication time duration of the server apparatus 103 and the application server apparatus 106.

More specifically, the management computer 105 calculates a difference between a time at which the data packets that are transmitted from the server apparatus 103 to the application server apparatus 106 are acquired and a time at which the ACK packets with respect to the data packets are acquired, to thereby calculate the network communication time duration of the server apparatus 103 and the application server apparatus 106.

The management computer 105 acquires the data packets in the vicinity of the server apparatus 103. For that reason, the management computer 105 deals with the time at which the data packets that are transmitted from the server apparatus 103 to the application server apparatus 106 are acquired as a time at which the server apparatus 103 transmits the data packet. Also, the management computer 105 deals with the time at which the ACK packet is acquired as the time at which the server apparatus 103 receives the ACK packet.

Subsequently, a description will be given of the calculation of the network communication time duration of the server apparatus 103 and the storage apparatus 102.

The management computer 105 calculates the network communication time duration of the server apparatus 103 and the storage apparatus 102 in the same manner as that of the calculation of the network communication time duration of the server apparatus 103 and the application server apparatus 106. Accordingly, the detailed description will be omitted.

Subsequently, a description will be given of the calculation of the response time duration of the application server apparatus 106.

The management computer 105 analyzes the communication protocol of the acquired packets, to thereby calculate the response time duration of the application server apparatus 106.

For example, a description will be given of a case in which the application server apparatus 106 has a web server function. In this case, the management computer 105 calculates a difference between a time at which packets including an HTTP (hypertext transfer protocol) request are acquired, and a time at which packets including an HTTP response to the HTTP request are acquired, to thereby calculate the response time duration of the application server apparatus 106.

In this example, the packets including the HTTP request are transmitted to the application server apparatus 106 from the server apparatus 103. Also, the packets including the HTTP response are transmitted to the server apparatus 103 from the application server apparatus 106.

The management computer 105 acquires the data packets in the vicinity of the server apparatus 103. For that reason, the management computer 105 deals with the time at which the packets including the HTTP request is acquired as the time at which the server apparatus 103 transmits the packets including the HTTP request. Also, the management computer 105 deals with the time at which the packets including the HTTP response is acquired as the time at which the server apparatus 103 receives the packets including the HTTP response.

However, the management computer 105 calculates the response time duration of the application server apparatus 106 in the same manner as that of the calculation of the processing time duration of the server apparatus 103 in the case where the management computer 105 is incapable of analyzing the communication protocol of the acquired packets. Then, the management computer 105 subtracts the network communication time duration of the server apparatus 103 and the application server apparatus 106 from the calculated response time duration of the application server apparatus 106, to thereby calculate the processing time duration of the application server apparatus 106.

Subsequently, a description will be given of the calculation of the response time duration of the storage apparatus 102.

The management computer 105 calculates the response time duration of the storage apparatus 102 in the same manner as that of the calculation of the response time duration of the application server apparatus 106. Accordingly, the detailed description will be omitted.

Then, the management computer 105 analyzes the packet information that is stored in the database, to thereby identify the communication information. Then, the management computer 105 stores the identified communication information as the use history of the server apparatus 103 (304).

The communication information is a communication activity of the user of the terminal computer 107. More specifically, the communication information includes the IP address of the terminal computer 107, the position of the terminal computer 107 on the network 110, the IP address of the server apparatus 103, the time at which the terminal computer 107 accesses the server apparatus 103, the amount of communication data, the type of application programs that operate on the server apparatus 103, and the frequency at which the terminal computer 107 accesses the server apparatus 103.

The position of the terminal computer 107 on the network 110 indicates whether the terminal computer 107 exists on an in-house network or the external network. Also, in the case where the terminal computer 107 exists on the in-house network, the position of the terminal computer 107 on the network 110 may indicate in which office the terminal computer 107 exists. Also, in the case where the terminal computer 107 exists on the external network, the position of the terminal computer 107 on the network 110 may indicate on the network provided by which internet provider the terminal computer 107 exists.

The management computer 105 extracts the IP address of the terminal computer 107 which is a transmitter or a receiver of the packet from the packet information which is stored in the database. Subsequently, the management computer 105 identifies the position of the terminal computer 107 on the network 110 on the basis of the extracted IP address of the terminal computer 107.

The management computer 105 deals with one piece of input information and a response to the one piece of input information as one access. The management computer 105 counts up the number of accesses. Then, the management computer 105 calculates the number of accesses per a unit time as an access frequency.

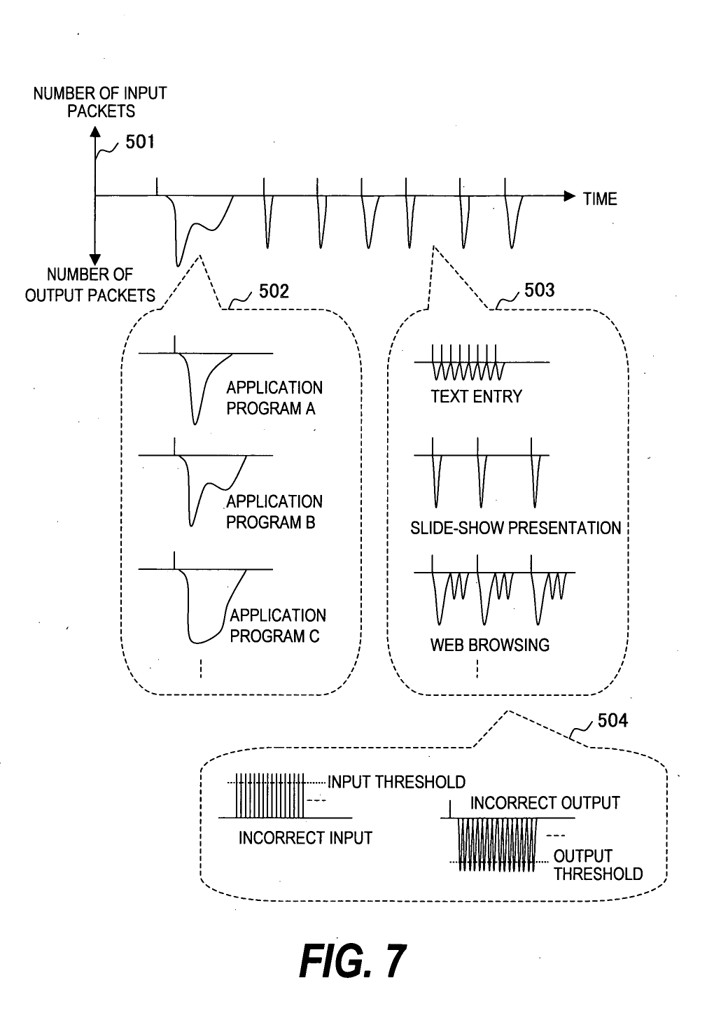

Also, the management computer 105 identifies the type of application program that operates on the server apparatus 103 on the basis of the time change in the number of packets which are outputted from the server apparatus 103. The identifying process of the type of application program will be described in more detail with reference to FIG. 7.

In addition, the management computer 105 may analyze the packet information that is stored in the database, to thereby detect an incorrect communication which is caused by the server apparatus 103. For example, the management computer 105 determines that the terminal computer 107 conducts the incorrect communication in the case where the packets of the number that is equal to or higher than a threshold value are inputted to the server apparatus 103 for a given period of time or longer. Also, the management computer 105 determines that the server apparatuses 107 conducts the incorrect communication in the case where the packets of the number that is equal to or higher than a threshold value are outputted from the server apparatus 103 for a given period of time or longer. The detection of incorrect communication will be described in more detail with reference to FIG. 7.

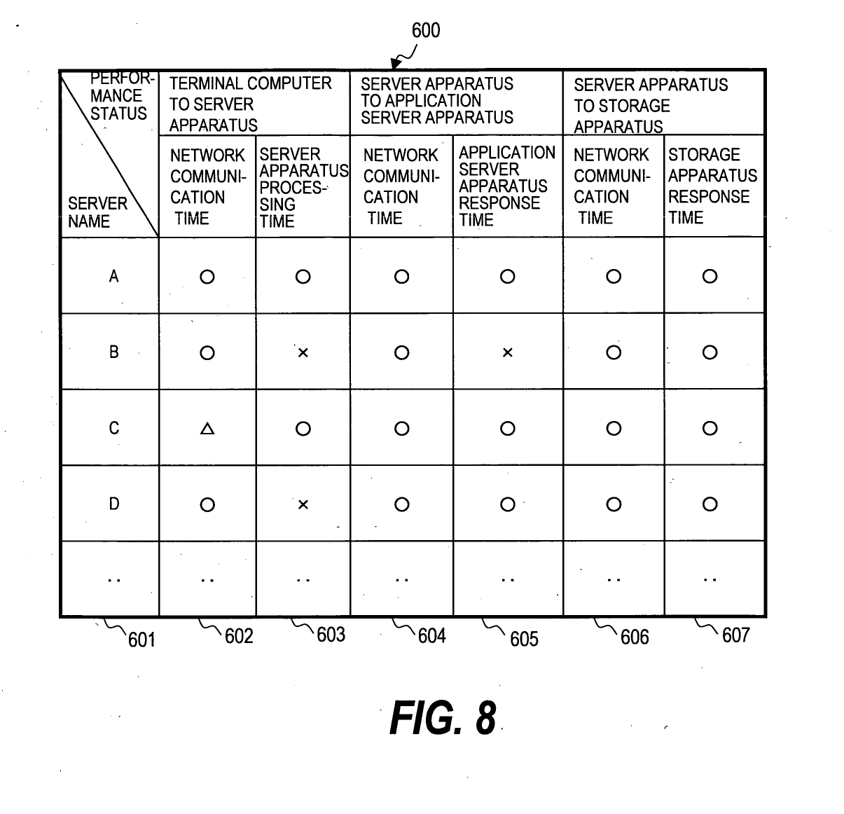

Subsequently, the management computer 105 displays the analysis result of the packet information on the terminal computer 107 (305). For example, the management computer 105 displays the processing time duration of the server apparatus 103 and the network communication time duration from the server apparatus 103 on the terminal computer 107. In this situation, the management computer 105 uses the web server function or the like to thereby display the analysis result of the packet information on the terminal computer 107. Also, the management computer 105 may display the analysis result of the packet information by itself. The display screen related to the analysis result of the packet information will be described with reference to FIGS. 8 to 10.

Then, the management computer 105 identifies the cause of the performance deterioration on the basis of the calculated response time duration, network communication time duration, and processing time duration. Then, the management computer 105 conducts processing corresponding to the identified cause of the performance deterioration (305).

For example, the management computer 105 transmits the detected information related to the cause of the performance deterioration to the server apparatus 103. Then, the server apparatus 103 displays the information related to the cause of the performance deterioration on the terminal computer 107, to thereby notify the user of the terminal computer 107 of the cause of the performance deterioration. More specifically, the server apparatus 103 displays an icon mark indicative of a portion that causes the performance deterioration on a task tray of the screen on the terminal computer 107.

Also, the management computer 105 may transmit an alert message so as to notify the user of the terminal computer 107 of the information related to the cause of the performance deterioration.

Also, upon detection of the incorrect communication due to the server apparatus 103, the management computer 105 instructs the blockage of the ports of the network apparatus which is connected with the server apparatus 103. With this operation, the management computer 105 blocks the transmission traffic of the server apparatus 103. Likewise, upon detection of the incorrect communication due to the terminal computer 107, the management computer 105 instructs the blockage of the ports of the network apparatus which is connected with the terminal computer 107. With this operation, the management computer 105 blocks the transmission traffic of the terminal computer 107. In this situation, the management computer 105 transmits the alert message, to thereby notify the user of the terminal computer 107 of the apparatus name that conducts the incorrect communication and the information related to the blockage of the port.

FIG. 6 is an explanatory diagram showing the calculating process of the processing time duration of the server apparatus 103 which is conducted by the management computer 105.

The management computer 105 calculates the processing time duration of the server apparatus 103 on the basis of the number of packets (input packets) that are transmitted from the terminal computer 107 to the server apparatus 103 and the number of packets (output packets) that are transmitted from the server apparatus 103 to the terminal computer 107. The management computer 105 may calculate the processing time duration of the server apparatus 103 on the basis of not the number of packets but the added values of the sizes of packets.

FIG. 6 includes a graph 401. The graph 401 shows the correspondence of the number of input packets and the number of output packets with respect to a time. The abscissa axis of the graph 401 is indicative of a time, and the ordinate axis of the graph 401 is indicative of the number of input packets in the positive direction. Also, the ordinate axis of the graph 401 is indicative of the number of output packets in the negative direction.

The management computer 105 acquires the packets in the vicinity of the server apparatus .103, and therefore deals with the time at which the input packets are acquired as a time at which the server apparatus 103 receives the input packets. Also, the management computer 105 deals with the time at which the output packets are acquired as a time at which the server apparatus 103 transmits the output packets.

FIG. 6 shows a case in which the terminal computer 107 uses the terminal server function provided by the server apparatus 103. The terminal computer 107 transmits the packets including the information that is inputted from a keyboard, a mouse, or the like to the server apparatus 103. The server apparatus 103 transmits the packets including the screen information corresponding to the received input information to the terminal computer 107.

That is, the ordinate axis of the graph 401 is indicative of the number of packets including the input information per a unit time in the positive direction. Also, the ordinate axis of the graph 401 is indicative of the number of packets including the screen information per a unit time in the negative direction.

In general, since the input information is small in the amount of information, the input packets corresponding to one piece of input information is about several packets. On the other hand, since the screen information is large in the amount of information, the output packets corresponding to one piece of screen information may be about several tens to several hundreds packets.

Also, the input packets and the output packets are transferred between the terminal computer 107 and the server apparatus 103 in the burst fashion. In this situation, the management computer 105 counts up the number of input packets and the number of output packets which are acquired by a unit time. For example, the management computer 105 counts up the number of input packets and the number of output packets with an appropriate time such as 0.0001 seconds, 0.001 seconds, or 0.01 seconds as a unit time.

In this situation, the management computer 105 calculates the moving average of the number of counted output packets, thereby making it possible to definitely grasp the time change in the output packets. For example, a blowing 402 is indicative of the moving average of the number of output packets.

In the case where the time change in the number of output packets is large, the moving average of the number of output packets corresponding to one piece of input information has a plurality of peaks. In this situation, the management computer 105 increases the unit time and calculates the moving average of the output packets. As a result, the management computer 105 is capable of calculating the moving average having one peak. An upper limit of the unit time is determined in advance.

Subsequently, the calculation of the processing time duration of the server apparatus 103 by using the blowing 403 will be described.

The management computer 105 estimates the time at which the input packets are acquired as a time at which the server apparatus 103 starts the processing. Also, the management computer 105 estimates a time at which a time slope of the number of output packets changes from positive or 0 to negative after the input packets have been acquired as a response start time of the server apparatus 103. That is, the management computer 105 estimates a time at which the moving average of the number of output packets starts increasing as a response start time of the server apparatus 103.

Also, the management computer 105 estimates a time at which a time slope of the number of output packets changes from positive or 0 to negative after the response start time as a response end time of the server apparatus 103. That is, the management computer 105 estimates a time at which the moving average of the number of output packets stops decreasing as a response end time of the server apparatus 103.

Then, the management computer 105 estimates a time duration corresponding to an amount of time between when the input packets are acquired and when the moving average of the number of output packets stops decreasing as the processing time duration of the server apparatus 103. Accordingly, the management computer 105 subtracts the estimated processing start time from the estimated response end time, to thereby calculate the processing time duration of the server apparatus 103.

The server apparatus 103 may transmit the output packets to the terminal computer 107 without receiving the input packets. For example, the server apparatus 103 transmits the output packets including the screen information related to the automatic blinking of a cursor without receiving the input packets.

In this case, the management computer 105 estimates the response start time of the server apparatus 103 as the processing start time of the server apparatus 103. That is, the management computer 105 estimates a time duration corresponding to an amount of time between when the moving average of the number of output packets starts increasing and when the moving average of the number of output packets stops reducing as the processing time duration of the server apparatus 103.

Also, the management computer 105 estimates the response start time of the server apparatus 103 as the processing start time of the server apparatus 103 even in the case where a correspondence of the input packets and the output packets is not known. That is, the management computer 105 estimates a time duration corresponding to an amount of time between when the moving average of the number of output packets starts increasing and when the moving average of the number of output packets stops decreasing as the processing time duration of the server apparatus 103.

FIG. 7 is an explanatory diagram showing a specifying process of the type of application program that is conducted by the management computer 105.

The management computer 105 calculates the moving average of the number of output packets in the same manner as that of the calculation of the processing time duration of the server apparatus 103. The management computer 105 produces a graph 501 indicative of a correspondence of the calculated moving average and the time. Then, the management computer 105 identifies the type of application program that operates on the server apparatus 103 on the basis of the produced graph 501.

The management computer 105 stores templates 502 and 503 of the traffic pattern in advance.

The template 502 of the traffic pattern corresponds to the application program that operates on the server apparatus 103. For example, the template 502 of the traffic pattern shows a time change in the number of the output packets at the time of starting the application program. In this case, the management computer 105 matches the waveform of the produced graph 501 with the template 502 of the traffic pattern at the time of starting the application program in pattern, to thereby identify the type of application program that operates on the server apparatus 103.

Also, the template 503 of the traffic pattern corresponds to the using method of application program that operates on the server apparatus 103. The using method of the application program is, for example, a text entry, a slide-show presentation, or a web browsing.

The management computer 105 matches the waveform of the produced graph 501 with the template 503 of the traffic pattern in pattern, to thereby identify the using method of application program that operates on the server apparatus 103. The management computer 105 may identify the type of application program that operates on the server apparatus 103 with reference to the identified using method.

A DP matching (dynamic programming matching) manner is used in the pattern matching.

In addition, in the case where the server apparatus 103 communicates with the application server apparatus 106 immediately before the server apparatus 103 transmits the output packets to the terminal computer 107, the management computer 105 refers to the type of a function provided in the application server apparatus 106. As a result, the management computer 105 is capable of improving accuracy of identifying the application program that operates on the server apparatus 103. For example, in the case where the server apparatus 103 communicates with the application server apparatus 106 having a proxy server function, the management computer 105 estimates that the web browser starts on the server apparatus 103.

The management computer 105 may store the template 504 of the traffic pattern in advance. The template 504 of the traffic pattern corresponds to the incorrect input to the. server apparatus 103 and the incorrect output from the server apparatus 103.

In this case, the management computer 105 compares the waveform of the produced graph 501 with the template 504 of the traffic pattern, thereby making it possible to detect the incorrect communication due to the server apparatus 103 and the incorrect communication due to the terminal computer 107.

FIG. 8 is an explanatory diagram showing a display screen 600 related to the analysis result of the packet information.

The display screen 600 related to the analysis result of the packet information may be displayed on the management computer 105, or may be displayed on the terminal computer 107.

The display screen 600 related to the analysis result of the packet information includes a server apparatus name 601 and the performance status.

The server apparatus name 601 is a designation for identifying the server apparatus 103 provided in the data center 101. The performance status is information related to the performance of the server apparatus 103 identified by the server apparatus name 601 of the record.

The performance status includes a status 602 related to the network communication time duration of the terminal computer 107 and the server apparatus 103, a status 603 related to the processing time duration of the server apparatus 103, a status 604 related to the network communication time duration of the server apparatus 103 and the application server apparatus 106, a status 605 related to the response time duration of the application server apparatus 106, a status 606 related to the network communication time duration of the server apparatus 103 and the storage apparatus 102, and a status 607 related to the response time duration of the storage apparatus 102.

The management computer 105 stores threshold values in the respective statuses 602 to 607. Then, the management computer 105 compares the stored threshold value with the calculated time duration, to thereby determine the performance status. The calculated time duration is any one of the calculated network communication time duration, the calculated processing time duration, and the calculated response time duration.

In this drawing, the management computer 105 stores two threshold values in the respective statuses 602 to 607.

In the case where the calculated time is shorter than a first threshold value, the management computer 105 determines that the performance status is good. Then, the management computer 105 stores a mark “O” in the statuses 602 to 607. Also, in the case where the calculated time is equal to or longer than the first threshold value and shorter than a second threshold value, the management computer 105 determines that the performance status is relatively bad. Then, the management computer 105 stores a mark “Δ” in the statuses 602 to 607. Also, in the case where the calculated time is equal to or longer than the second threshold value, the management computer 105 determines that the performance status is bad. Therefore, the management computer 105 stores a mark “X” in the statuses 602 to 607.

The user of the terminal computer 107 refers to the display screen 600 related to the analysis result of the packet information, thereby making it possible to identify the cause of the processing delay. More specifically, the user of the terminal computer 107 identifies the server apparatus 103 that causes the processing delay, the position on the network 110 which causes the processing delay, or the like.

Also, an administrator who operates the management computer 105 may refer to the display screen 600 related to the analysis result of the packet information, to thereby identify the cause of the processing delay. Also, the management computer 105 may automatically identify the cause of the processing delay.

In this example, a description will be given of a response delay from a server apparatus B 103 that is identified by “B” of the server apparatus name 601. According to the display screen 600, the causes of the response delay from the server apparatuses B103 are the processing time duration of the server apparatus B103 and the processing time duration of the application server apparatus 106. In this way, even if there are a plurality of response delay causes from the server apparatus 103, the user of the terminal computer 107 is capable of readily identifying the causes.

Subsequently, a description will be given of a response delay from the server apparatus D103 that is identified by a mark “D” of the server apparatus name 601. According to the display screen 600, the cause of the response delay from the server apparatus D103 is the processing time duration of the server apparatus D103.

Also, in the case where the performance status of the network communication time duration is bad, the user of the terminal computer 107 identifies a network segment that causes the processing delay. For example, the management computer 105 sorts the display screen 600 related to the analysis result of the packet information on the basis of the IP address of the server apparatus 103, the terminal computer 107, the application server apparatus 106, or the storage apparatus 102. Then, the user of the terminal computer 107 identifies the network segment that causes the processing delay with reference to the sorted display screen 600. The management computer 105 may automatically identify the network segment that causes the processing delay.

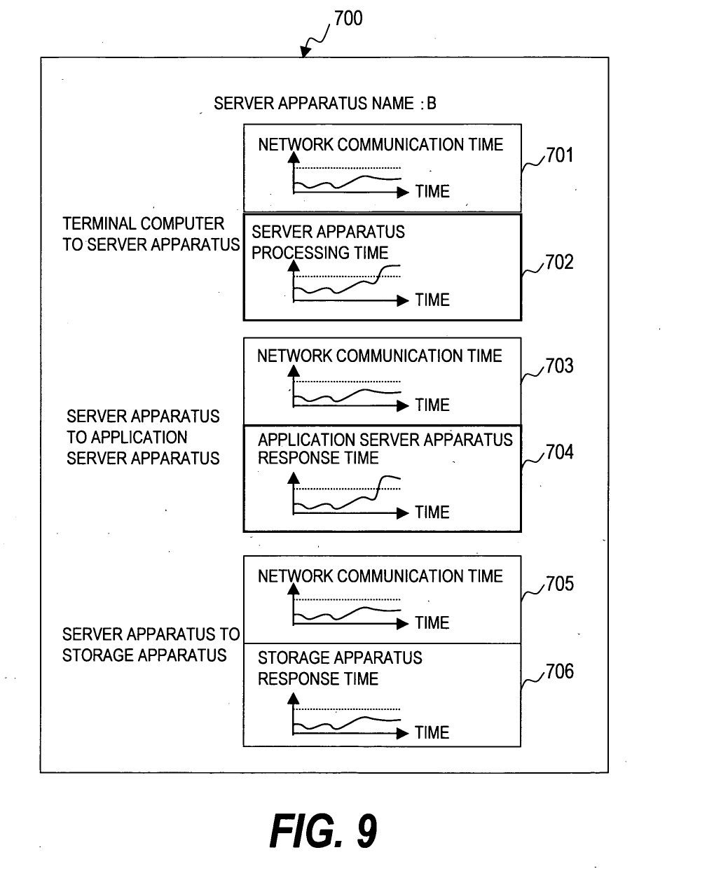

FIG. 9 is an explanatory diagram showing the display screen 700 related to the analysis result of the packet information.

In the display screen 700 related to the analysis result of the packet information, the information related to the performance of the server apparatus B103 which is identified by the mark “B” of the server apparatus name 601 is expressed by the graph. More specifically, six graphs 701 to 706 are displayed on the display screen 700 related to the analysis result of the packet information.

The graph 701 indicates a correspondence of the network communication time duration of the terminal computer 107 and the server apparatus 103, and the time. The graph 702 indicates a correspondence of the processing time duration of the server apparatus 103 and the time. The graph 703 indicates a correspondence of the network communication time duration of the server apparatus 103 and the application server apparatus 106, and the time. The graph 704 indicates a correspondence of the response time duration of the application server apparatus 106 and the time. The graph 705 indicates a correspondence of the network communication time duration of the server apparatus 103 and the storage apparatus 102, and the time. The graph 706 indicates a correspondence of the response time duration of the storage apparatus 102 and the time.

The user of the terminal computer 107 refers to the display screen 700 related to the analysis result of the packet information to visually identify the cause of the response delay from the server apparatus B103. More specifically, the user of the terminal computer 107 is capable of identifying that the response delay is caused by the processing time duration of the server apparatus B103 and the response time duration of the application server apparatus 106.

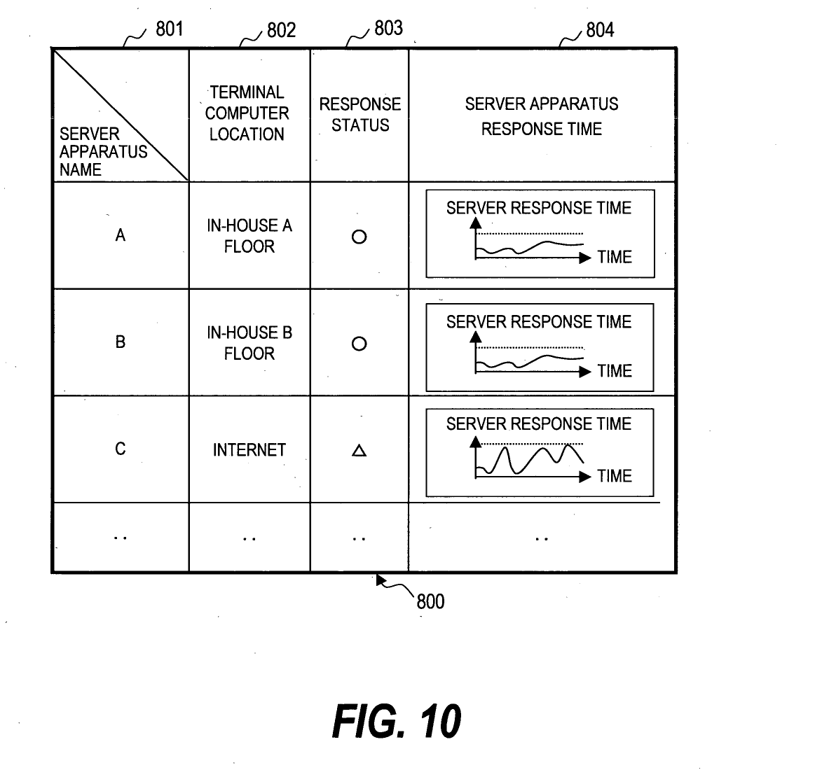

FIG. 10 is an explanatory diagram showing the display screen 800 related to the analysis result of the packet information.

The display screen 800 related to the analysis result of the packet information displays the response time duration and the response status of the server apparatus 103. More specifically, the display screen 800 related to the analysis result of the packet information displays thereon the server apparatus name 801, the position 802 of the terminal computer, the response status 803, and the response time duration 804 of the server apparatuses 103.

The server apparatus name 801 is a designation for identifying the server apparatus 103 provided to the data center 101.

The position 802 of the terminal computer is a position of the terminal computer 107 that accesses the server apparatus 103 identified by the server apparatus name 801 in the record on the network 110. For example, the in-house (office) floor or the Internet is stored at the position 802 of the terminal computer. The position 802 of the terminal computer is identified by analysis of the above-mentioned packet information. The management computer 105 identifies the position 802 of the terminal computer on the basis of the IP address of the terminal computer 107 which is a transmitter or a receiver of the packet.

The response status 803 is a status of the response time duration of the server apparatus 103. More specifically, the management computer 105 compares the response time duration of the server apparatus 103 with a threshold value related to the response time duration of the server apparatus 103 to thereby determine the response status of the server apparatus 103. When the management computer 105 determines that the response status is good, the management computer 105 then stores a mark “O” in the response status 803. Also, when the management computer 105 determines that the response status is relatively bad, the management computer 105 then stores a mark “Δ” in the status 803. Also, when the management computer 105 determines that the response status is bad, the management computer 105 then stores a mark “X” in the status 803.

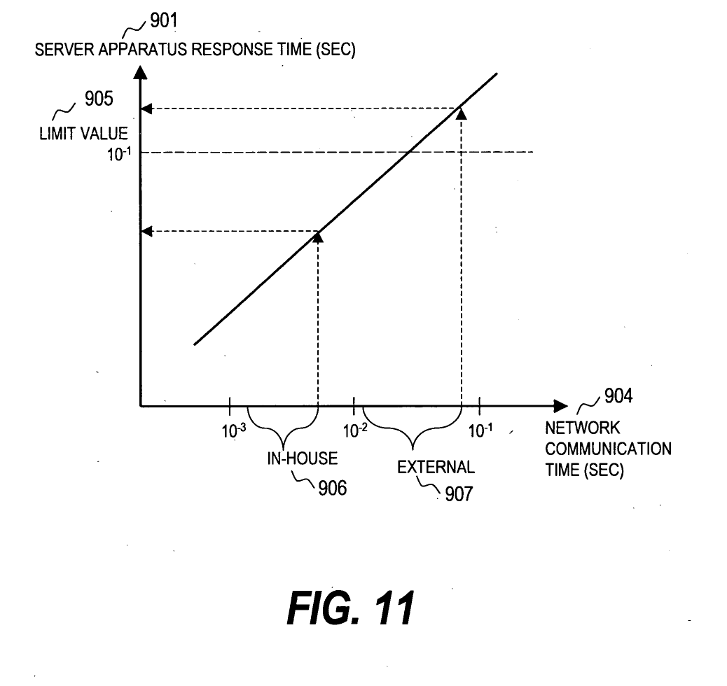

A threshold value related to the response time duration of the server apparatus 103 will be described in more detail with reference to FIG. 11.

Stored in the response time duration 804 of the server apparatus is a graph related to the response time duration in the server apparatus 103 that is identified by the server apparatus name 801 in the record. The graph shows a correspondence of the response time duration of the server apparatus 103 and the time.

FIG. 11 is an explanatory diagram showing a threshold value related to the response time duration of the server apparatus 103.

The management computer 105 determines a threshold value related to the response time duration of the server apparatus 103 with reference to the graph shown in FIG. 11. The management computer 105 may use another method to determine the threshold value related to the response time duration of the server apparatus 103. The threshold value related to the response time duration of the server apparatus 103 may not be determined by the management computer 105, but may be determined by an administrator who operates the management computer 105 in advance.

The ordinate axis of the graph shown in FIG. 11 is a response time duration 901 of the server apparatus. Also, the abscissa axis of the graph is a network communication time duration 904 of the server apparatus and the terminal computer. The graph shown in FIG. 11 exhibits the maximum value of the response time duration of the server apparatus with respect to the network communication time duration. The maximum value of the response time duration of the server apparatus is the maximum value of the response time durations of the plurality of applications executed by the server apparatus 103.

Also, a limit value 905 of the server apparatus with respect to the response time duration 901 is determined in advance. The limit value 905 is a time duration during which the user of the terminal computer 107 certainly feel the delay. In FIG. 11, the limit value 905 is set to 0.1 second.

First, the management computer 105 identifies the position of the terminal computer 107 on the network 110. Then, the management computer 105 estimates the maximum value of the network communication time duration corresponding to the identified position. In the graph shown in FIG. 11, the network communication time duration corresponding to the position of the terminal computer 107 on the network 110 is set. More specifically, a range of the network communication time duration in a case where the terminal computer 107 exists on an in-house 906 network, and a range of the network communication time duration in a case where the terminal computer 107 exists on an external 907 network are set. In the case where the terminal computer 107 exists on the in-house 906 network, the terminal computer 107 accesses the server apparatus 103 through the intranet. On the other hand, in the case where the terminal computer 107 exists on the external 907 network, the terminal computer 107 accesses the server apparatus 103 through the Internet.

The management computer 105 identifies the maximum value of the response time duration of the server apparatus 103 with respect to the maximum value of the estimated network communication time duration on the basis of the graph shown in FIG. 11. Then, the management computer 105 determines whether or not the maximum value of the response time duration of the identified server apparatus is larger than the limit value 905.

In a case where the maximum value of the response time duration of the server apparatus is larger than the limit value 905, the management computer 105 sets the limit value 905 as a threshold value related to the response time duration of the server apparatus 103. On the other hand, in a case where the maximum value of the response time duration of the server apparatus is equal to or smaller than the limit value 905, the management computer 105 sets the maximum value of the response time duration of the identified server apparatus as a threshold value related to the response time duration of the server apparatus 103.

As described above, the management computer 105 is capable of determining the threshold value related to the response time duration of the server apparatus 103 which corresponds to the position of the terminal computer 107 on the network. The management computer 105 may always set the limit value 905 as the threshold value related to the response time duration of the server apparatus 103.

Also, the management computer 105 may estimate the response time duration of the server apparatus 103 on the basis of the calculated network communication time duration of the server apparatus 103 and the terminal computer 107 and the graph shown in FIG. 11.

As described above, the management computer 105 according to this embodiment is capable of calculating the processing time duration of the server apparatus 103 on the basis of the packet inputted to the server apparatus 103 and the packet outputted from the server apparatus 103. In addition, the management computer 105 is capable of calculating the network communication time duration of the terminal computer 107 and the server apparatus 103, the processing time duration of the application server apparatus 106, the network communication time duration of the server apparatus 103 and the application server apparatus 106, the processing time duration of the storage apparatus 102, and the network communication time duration of the server apparatus 103 and the storage apparatus 102. As a result, the management computer 105 is capable of identifying the cause of the processing delay of the communication system.

According to this invention, the processing time duration of the server apparatus can be calculated.

While the present invention has been described in detail and pictorially in the accompanying drawings, the present invention is not limited to such detail but covers various obvious modifications and equivalent arrangements, which fall within the purview of the appended claims.

What is claimed is:

1. A management computer connected to a server apparatus which is connected to a terminal computer through a network, the management computer comprising:
a processor;
a memory; and
an interface, wherein:
the processor acquires packets outputted from the server apparatus and packets inputted to the server apparatus;
the processor estimates a time at which the server apparatus starts to process the acquired input packets;
the processor estimates a time at which the server apparatus completes a response to the acquired input packets based on a time change in a number of the acquired output packets; and
the processor calculates the packet processing time duration of the server apparatus by subtracting the estimated processing start time from the estimated response completion time.

2. The management computer according to claim 1, wherein:
the processor calculates the moving average value of the number of the acquired output packets; and
the processor estimates a time at which the server apparatus completes a response to the acquired input packets based on the moving average value thus calculated.

3. The management computer according to claim 2, wherein the processor estimates a time at which the calculated moving average value stops decreasing as the time at which the server apparatus completes the response to the acquired input packets.

4. The management computer according to claim 1, wherein:
the processor identifies a time at which the acquired input packets are inputted to the server apparatus; and
the processor estimates the identified input time as the time at which the server apparatus starts to process the acquired input packets.

5. The management computer according to claim 1, wherein the processor estimates the time at which the server apparatus starts to process the acquired input packets based on the time change in the number of the acquired output packets.

6. The management computer according to claim 1, wherein:
the processor identifies a time at which the acquired output packets are outputted from the server apparatus;
the processor identifies a time at which arrival acknowledgement packets with respect to the acquired output packets are inputted to the server apparatus;
the processor calculates a communication time duration from the server apparatus to the terminal computer by subtracting the identified output time of the output packets from the identified input time of the arrival acknowledgement packets;
the processor estimates a communication time duration from the terminal computer to the server apparatus based on the calculated communication time duration from the server apparatus to the terminal computer; and
the processor calculates the packet response time duration of the server apparatus by adding the estimated communication time duration from the terminal computer to the server apparatus to the calculated packet processing time duration of the server apparatus.

7. The management computer according to claim 1, wherein:
the server apparatus is connected to an application server apparatus for providing the server apparatus with a service; and
the processor calculates the packet response time duration of the application server apparatus and the communication time duration from the server apparatus to the application server apparatus by protocol-analyzing the packets inputted from the application server apparatus among the acquired input packets, and the packets outputted to the application server apparatus among the acquired output packets.

8. The management computer according to claim 1, wherein:
the server apparatus is connected to a storage apparatus for providing the server apparatus with a storage area; and
the processor calculates the packet response time duration of the storage apparatus and the communication time duration from the server apparatus to the storage apparatus by protocol-analyzing the packets inputted from the storage apparatus among the acquired input packets, and the packets outputted to the storage apparatus among the acquired output packets.

9. The management computer according to claim 1, wherein the processor identifies a type of application program executed by the server apparatus based on the time change in the number of the acquired output packets.

10. The management computer according to claim 1, wherein:
the processor detects an incorrect communication of the server apparatus based on the time change in the number of the acquired output packets; and
the processor instructs a blockage of a communication port of the server apparatus from which the incorrect communication is detected.

11. A communication system, comprising:
a server apparatus that is connected to a terminal computer through a network, and includes a processor, a memory, and an interface; and
a management computer that is connected to the server apparatus and includes a processor, a memory, and an interface, wherein:
the management computer acquires packets outputted from the server apparatus and packets inputted to the server apparatus;
the management computer estimates a time at which the server apparatus starts to process the acquired input packets;
the management computer estimates a time at which the server apparatus completes the response to the acquired input packets based on a time change in a number of the acquired output packets; and
the management computer calculates the packet processing time duration of the server apparatus by subtracting the estimated processing start time from the estimated response completion time.

12. The communication system according to claim 11, wherein:
the management computer calculates the moving average value of the number of the acquired output packets; and
the management computer estimates a time at which the server apparatus completes a response to the acquired input packets based on the moving average value thus calculated.

13. The communication system according to claim 12, wherein the management computer estimates a time at which the calculated moving average value stops decreasing as the time at which the server apparatus completes the response to the acquired input packets.

14. The communication system according to claim 11, wherein:
the management computer identifies a time at which the acquired input packets are inputted to the server apparatus; and
the management computer estimates the identified input time as the time at which the server apparatus starts to process the acquired input packets.

15. The communication system according to claim 11, wherein the management computer estimates the time at which the server apparatus starts to process the acquired input packets based on the time change in the number of the acquired output packets.

16. The communication system according to claim 11, wherein:
the management computer identifies a time at which the acquired output packets are outputted from the server apparatus;
the management computer identifies a time at which arrival acknowledgement packets with respect to the acquired output packets are inputted to the server apparatus;
the management computer calculates a communication time duration from the server apparatus to the terminal computer by subtracting the identified output time of the output packets from the identified input time of the arrival acknowledgement packets;
the management computer estimates a communication time duration from the terminal computer to the server apparatus based on the calculated communication time duration from the server apparatus to the terminal computer; and
the management computer calculates the packet response time duration of the server apparatus by adding the estimated communication time duration from the terminal computer to the server apparatus to the calculated packet processing time duration of the server apparatus.

17. The communication system according to claim 11, further comprising an application server connected to the server apparatus for providing the server apparatus with a service,
wherein the management computer calculates the packet response time duration of the application server apparatus and the communication time duration from the server apparatus to the application server apparatus by protocol-analyzing the packets inputted from the application server apparatus among the acquired input packets, and the packets outputted to the application server apparatus among the acquired output packets.

18. The communication system according to claim 11, further comprising a storage apparatus connected to the server apparatus for providing the server apparatus with a storage area,
wherein the management computer calculates the packet response time duration of the application server apparatus and the communication time duration from the server apparatus to the storage apparatus by protocol-analyzing the packets inputted from the storage apparatus among the acquired input packets, and the packets outputted to the storage apparatus among the acquired output packets.

19. The communication system according to claim 11, wherein the management computer identifies a type of application program executed by the server apparatus based on the time change in the number of the acquired output packets.

20. The communication system according to claim 11, wherein:
the management computer detects an incorrect communication of the server apparatus based on the time change in the number of the acquired output packets; and
the management computer instructs a blockage of a communication port of the server apparatus from which the incorrect communication is detected.
